(19) United States
(12) Patent Application Publication
(10) Pub. No.: US 2009/0114412 A1
(43) Pub. Date: May 7, 2009

(54) POWER TOOL HAVING HOUSING WITH ENHANCED IMPACT RESISTANCE

(75) Inventor: Eric Hatfield, Jacobus, PA (US)

Correspondence Address: Harness Dickey & Pierce, P.L.C., P.O. Box 828, Bloomfield Hills, MI, 48303, US

(73) Assignee: Black and Decker Inc.

(21) Appl. No.: 12/255,738

(22) Filed: Oct. 22, 2008

Related U.S. Application Data
(60) Provisional application No. 61/001,875, filed on Nov. 5, 2007.

(51) Int. Cl. B23Q 5/00

(52) U.S. Cl. 173/217

(57) ABSTRACT

A power tool includes a tool housing and a motor received in the tool housing. The tool housing includes an end portion surrounding at least a rear portion of the motor. At least a portion of the end portion of the tool housing has a double-wall structure and includes an interior wall and an exterior wall. The interior wall and the exterior wall are spaced from each other. In an aspect, a plurality of ribs extend from the interior wall to the exterior wall in a direction transverse to the interior wall and the exterior wall. In an aspect, a plurality of the plurality of the ribs are not tied to the exterior wall.

### CROSS-REFERENCE TO RELATED APPLICATIONS

This application claims the benefit of U.S. Provisional Application No. 60/001,875, filed on Nov. 5, 2007. The entire disclosure of the above application is incorporated herein by reference.

### FIELD

The present disclosure relates generally to power tools and more particularly to power tools having housings with enhanced impact resistance.

### BACKGROUND

The statements in this section merely provide background information related to the present disclosure and may not constitute prior art.

A typical type of power tool includes a housing in which a motor is received. The motor drives a tool portion or tool holding portion that extends out of the housing. The housing may be a clamshell type of housing having two halves which are joined to each other. It should be understood that the housing may be other than a clamshell type of housing.

The housing of the power tool is generally made of synthetic resin and has a thin wall construction to provide a light-weight power tool to reduce a user's fatigue in operating the power tool.

### SUMMARY

In accordance with one aspect of the present disclosure, a power tool has a housing. A portion of the housing surrounds at least a part of a motor. At least portions of the housing surrounding the motor include a double wall having an interior wall spaced from an exterior wall. In an aspect of the present disclosure, the portion of the housing that surrounds the motor is an end portion of the housing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 illustrates a cross-sectional view of a power tool in accordance with an aspect of the present disclosure; and

FIG. 2 illustrates a partial cross-sectional view of the power tool of FIG. 1.

FIG. 3 illustrates a cross-sectional view of a power tool in accordance with another aspect of the present disclosure; and

FIG. 4 illustrates a partial cross-sectional view of the power tool of FIG. 3.

### DETAILED DESCRIPTION

The following description is merely exemplary in nature and is not intended to limit the present disclosure, application, or uses. Corresponding reference numerals indicate corresponding parts throughout the several views of the drawings.

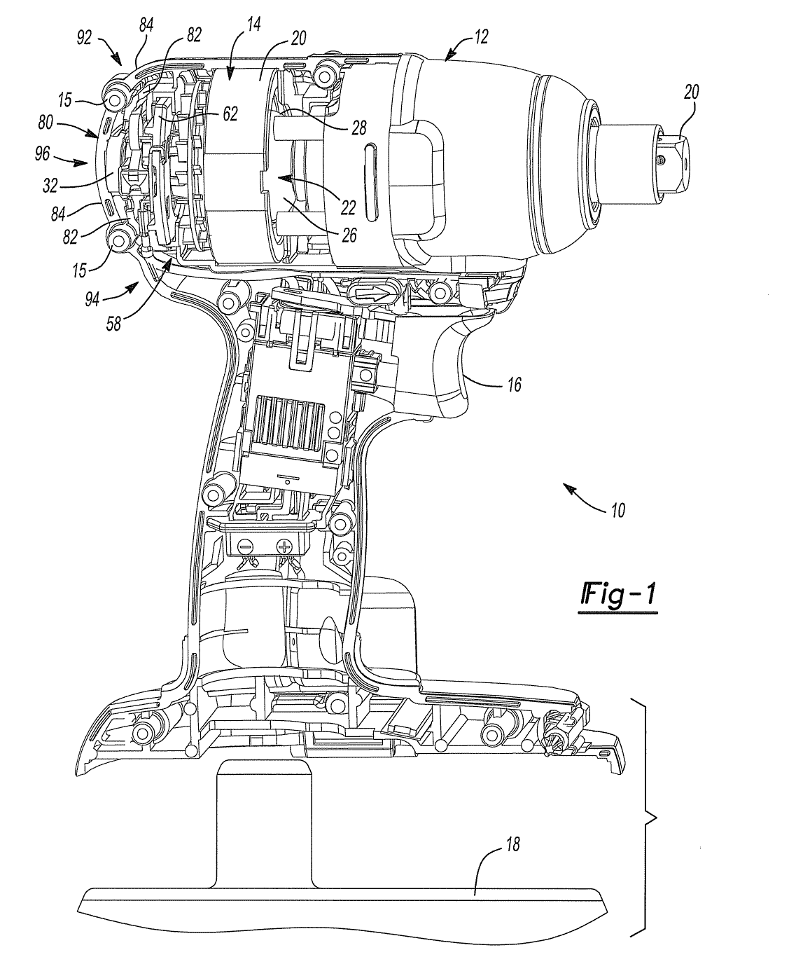

Referring to FIG. 1, a power tool in accordance with an aspect of the present disclosure is illustrated and designated with the reference numeral 10. The power tool 10 is illustrated as an impact driver; however, any type of power tool may be used with the brush assembly of the present disclosure. The power tool 10 includes a housing 12 which surrounds a motor 14. The motor 14 is a frameless motor because it does not have a frame or housing enclosing the stator assembly and rotor. An activation member 16 is coupled with the motor 14 as well as with a power source 18. The power source 18 may be a battery (DC current) or a power cord (AC current) (not shown). The motor 14 is coupled with an output 20 to retain a tool (not shown), such as a socket.

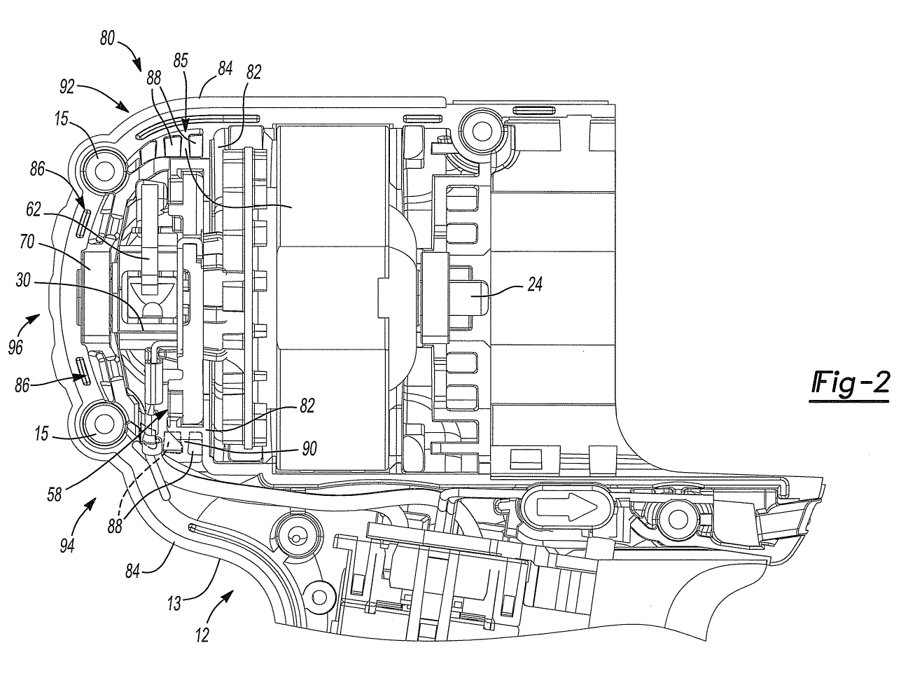

The motor 14 is illustratively a permanent magnet motor having a stator assembly 20 having magnets (not shown) surround an armature 22, which is also the rotor of motor 14. Armature 22, which is also the rotor of motor 14, includes a shaft 24 (FIG. 2) on which laminations 26 are affixed and windings 28 wound in slots (not shown) in laminations 46, as well as a commutator 30 (FIG. 2) affixed on the shaft 24. A front bearing (not shown) and rear bearing 32 for supporting opposing ends of the shaft 42 are received in tool housing 12. While motor 14 is shown as a permanent magnet motor, it should be understood that motor 14 could be a motor such as a universal series motor in which the stator includes laminations in which field windings are wound. Also, while motor 14 is shown as a frameless motor, it should be understood that motor 14 could be a motor having a frame.

The tool housing 12 may be a clamshell housing having two housing halves 13 (only one of which is shown in FIG. 2). Each housing half is illustratively formed of synthetic resin by injection molding. Each housing half illustratively has bosses 15 integrally formed therewith and extending in a transverse direction toward the other housing half 13. Screws (not shown) serving as fastening members pass through threaded holes of the bosses 15 to fasten the housing halves 13 into a united body. The tool housing 12 includes an end portion 80 that surrounds at least a rear portion 58 of the motor 14.

Turning to FIG. 2, the end portion 80 of tool housing 12 is disposed around the rear portion 58 of the motor 14 to surround at least a part of the motor 14. The end portion 80 can substantially or partially surround the rear portion 58 of the motor 14 to protect the brushes 63, which are part of brush assembly 62 and the commutator 30.

The end portion 80 has a double-wall structure and includes an interior wall 82 and an exterior wall 84. The interior wall 82 and the exterior wall 84 are spaced with a space 85 therebetween. The interior wall 82 and the exterior wall 84 merge and are connected at a connecting portion 86. In the illustrative aspect shown in FIGS. 1 and 2, the double wall structure is provided at upper rear portion 92 and lower rear portion 94 of housing 12. A central rear portion 96 illustratively does not have a double wall portion in that a rear of bearing 32 butts up against an inner surface of the exterior wall 84 of housing 12. Some of the bosses 15 that couple the housing halves 13 can be provided in the connecting portion 86. A plurality of ribs 88 are provided in the space 85 in a direction transverse to the interior wall 82 and the exterior wall 84. The plurality of ribs 88 extend from the interior wall 82 toward the exterior wall 84. Some, but not all of the ribs 88, may be tied to the exterior wall 84. For example, the ribs 88 are not tied to the exterior wall 84 in the area that typically suffers the most severe impact when the power tool 10 is dropped. This is typically the most rearward portion of end portion 80. The exterior wall 84 may have a plurality of openings 90 that communicate with the space 85 so that the heat generated from the motor 14 can be dissipated to the ambient environment through the openings 90.

The space 85 between the interior wall 82 and the exterior wall 84 isolates the interior wall 82 from exterior wall 84 so that when the exterior wall 84 deflects when the power tool 10 is dropped to the ground, the force transmitted to interior wall 82 is reduced. The ribs 88 help increase the deflecting strength of the exterior wall 84 and also absorb a part of the impact energy. With the exterior wall 84 and the ribs 88 absorbing a significant portion of the impact energy, less of the impact energy is transferred to the interior wall 82 and then to the motor 14. Therefore, the tool housing 12 with the double-wall end portion 80 has enhanced impact resistance to protect the motor 14 without significantly increasing the weight of the power tool 10. In an aspect, the end portion 80 having the double wall structure surrounds the commutator and brushes of motor 14 as maintaining the alignment of the brushes and commutator is important and this alignment tends to be sensitive to impact.

With the presence of the space 85 between the interior wall 82 and the exterior wall 84, the tool housing 12 also has the advantage of improved air circulation. Because the space 85 provides more room for air ventilation, the heat generated from the motor 14 can be dissipated relatively quickly to the ambient environment.

It should be understood and appreciated that while the end portion 80 of tool housing 12 is shown to extend over the entire rear portion 58 of the motor 14, the end portion 80 can extend over only a part of the rear portion 58. Alternatively, the end portion 80 can extend over a significant part of the motor 14 to more effectively protect the motor 14 against dropping.

Further, while the end portion 80 of tool housing 12 has been described and shown as an integral part of the tool housing 12, it should be understand and appreciated that the end portion 80 can be made as a separate component and coupled to the rest of tool housing 12 by any conventional fastening means, such as bosses and screws.

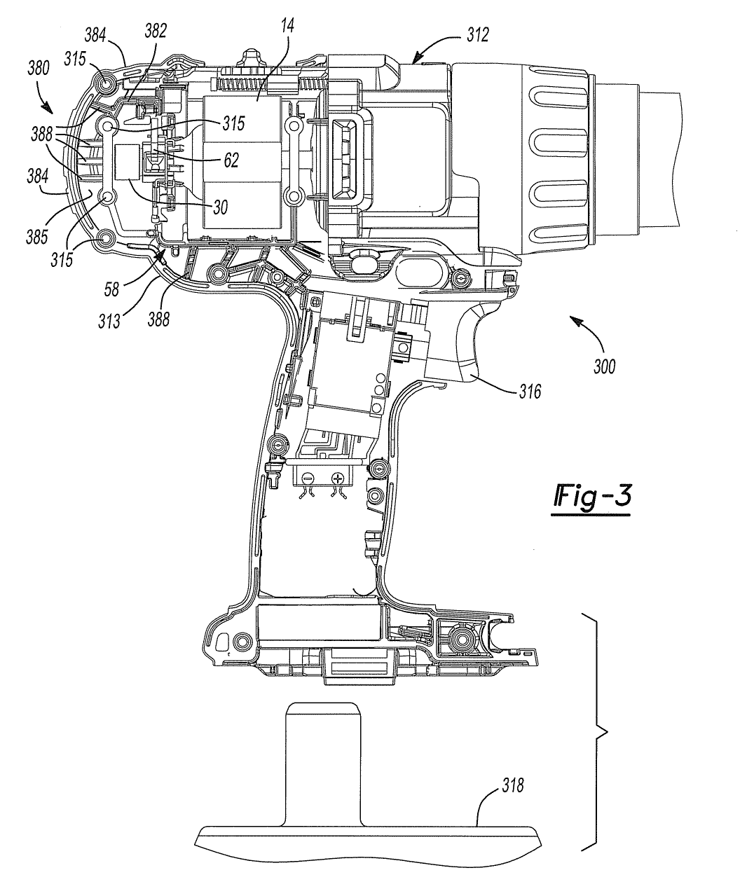

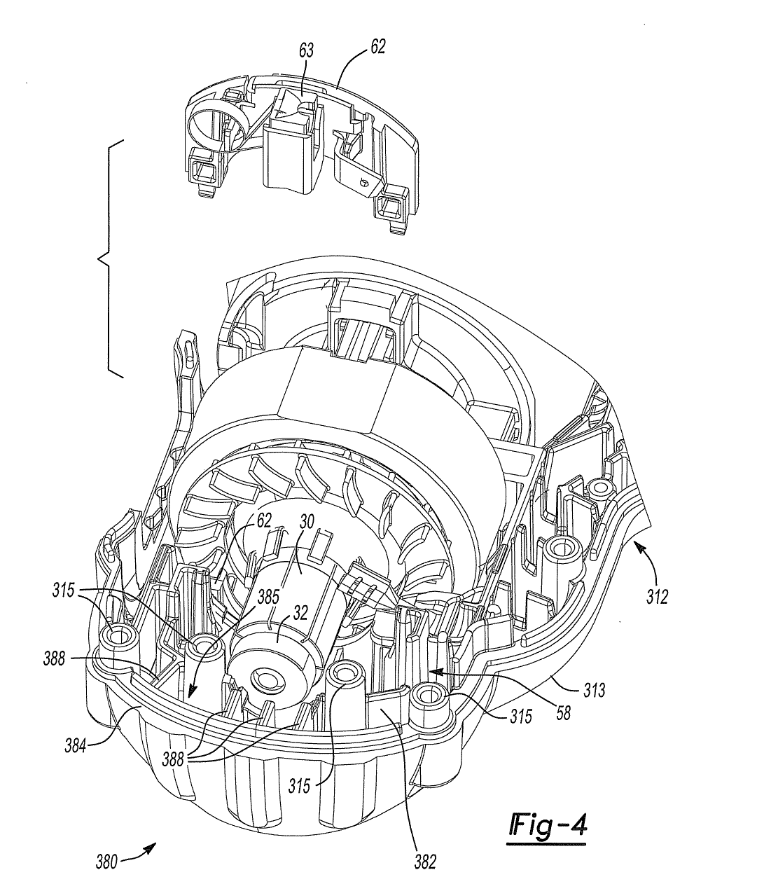

Referring to FIGS. 3 and 4, a power tool in accordance with another aspect of the present disclosure is illustrated and designated with the reference number 300. The power tool 300 is illustrated as a hammer drill; however, any type of power tool may be used with the 300 having a housing in which a motor is received. The power tool 10 includes a housing 312 which surrounds motor 14. An activation member 316 is coupled with the motor 14 as well as with a power source 318. The power source 318 may be a battery (DC current) or a power cord (AC current) (not shown). The motor 14 is coupled with an output 20 to retain a tool (not shown), such as a socket.

The motor 14 is illustratively a permanent magnet motor as described above. As discussed above, it should be understood that motor 14 could be a motor such as a universal series motor in which the stator includes laminations in which field windings are wound. Also, while motor 14 is shown as a frameless motor, it should be understood that motor 14 could be a motor having a frame.

The tool housing 312 may be a clamshell housing having two housing halves 313 (only one of which is shown in FIG. 4). Each housing half is illustratively formed of synthetic resin by injection molding. Each housing half illustratively has bosses 315 integrally formed therewith and extending in a transverse direction toward the other housing half 313. Screws (not shown) serving as fastening members pass through threaded holes of the bosses 315 to fasten the housing halves 313 into a united body. The tool housing 312 includes an end portion 380 that surrounds at least a rear portion 358 of the motor 14.

Turning to FIG. 4, the end portion 380 of tool housing 312 is disposed around the rear portion 58 of the motor 14 to surround at least a part of the motor 14. The end portion 380 can substantially or partially surround the rear portion 358 of the motor 14 to protect the brushes 62, which are part of brush assembly 62 and the commutator 30.

The end portion 380 has a double-wall structure and includes an interior wall 382 and an exterior wall 384. The interior wall 382 and the exterior wall 84 are spaced with a space 385 therebetween. In the illustrative aspect shown in FIGS. 3 and 4, the power tool housing has the double wall structure at the entire rear portion 380 and a rear of bearing 32 is spaced from exterior wall 384. A plurality of ribs 388 are provided in the space 85 in a direction transverse to the interior wall 382 and the exterior wall 384. The plurality of ribs 388 extend from the interior wall 382 toward the exterior wall 384. Some of these ribs 388 extend from interior 382 to exterior wall 384 where adjacent where bearing 32 is received in housing 312. Some, but not all of the ribs 388, may be tied to the exterior wall 384, particularly those adjacent bearing 32. The exterior wall 384 may have a plurality of openings (not shown) that communicate with the space 385 so that the heat generated from the motor 14 can be dissipated to the ambient environment through the openings.

The space 385 between the interior wall 382 and the exterior wall 384 isolates the interior wall 382 from exterior wall 384 so that when the exterior wall 384 deflects when the power tool 30 is dropped to the ground, the force transmitted to interior wall 382 is reduced. The ribs 388 help increase the deflecting strength of the exterior wall 384 and also absorb a part of the impact energy. With the exterior wall 384 and the ribs 388 absorbing a significant portion of the impact energy, less of the impact energy is transferred to the interior wall 82 and then to the motor 14. Therefore, the tool housing 312 with the double-wall end portion 380 has enhanced impact resistance to protect the motor 14 without significantly increasing the weight of the power tool 310. In an aspect, the end portion 380 having the double wall structure surrounds the commutator and brushes of motor 14 as maintaining the alignment of the brushes and commutator is important and this alignment tends to be sensitive to impact.

With the presence of the space 385 between the interior wall 382 and the exterior wall 384, the tool housing 312 also has the advantage of improved air circulation. Because the space 385 provides more room for air ventilation, the heat generated from the motor 14 can be dissipated relatively quickly to the ambient environment.

It should be understood and appreciated that while the end portion 380 of tool housing 312 is shown to extend over the entire rear portion 58 of the motor 14, the end portion 380 can extend over only a part of the rear portion 58. Alternatively, the end portion 380 can extend over a significant part of the motor 14 to more effectively protect the motor 14 against dropping.

Further, while the end portion 380 of tool housing 312 has been described and shown as an integral part of the tool housing 312, it should be understand and appreciated that the end portion 380 can be made as a separate component and coupled to the rest of tool housing 312 by any conventional fastening means, such as bosses and screws.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A power tool comprising:
a tool housing;
a motor received in the tool housing; and
the tool housing having an end portion that surrounds at least a rear portion of the motor, the end portion of the tool housing including an interior wall spaced from an exterior wall throughout at least portions of the end portion to provide a double wall structure housing thereat.

2. The apparatus of claim 1, wherein the motor includes brushes and a commutator, the end portion of the tool housing surrounding the brushes and the commutator.

3. The power tool of claim 1, wherein the interior wall includes a plurality of ribs that extend toward the exterior wall generally transverse to the interior wall and the exterior wall.

4. The apparatus of claim 3 wherein at least one of the plurality of ribs is not tied to the exterior wall.

5. The apparatus of claim 4 wherein a plurality of the plurality of ribs are not tied to the exterior wall at a rear most portion of the end portion of the tool housing.

6. The apparatus of claim 3 wherein at some of the ribs extend from the interior wall to the exterior wall adjacent where a bearing supporting a shaft of the motor is received in the tool housing.

7. The apparatus of claim 1 wherein the entire end portion of the tool housing that surrounds at least the rear of the motor have the double wall housing structure.

8. The apparatus of claim 1 upper and lower portions of the end portion of the tool housing have the double wall housing but a central portion of the end portion does not have the double wall housing structure.

9. The apparatus of claim 1, wherein the tool housing includes a clamshell housing having first and second halves that are joined together.

10. The apparatus of claim 9, wherein the end portion is an integral part of the tool housing.
